(19) United States
(12) Patent Application Publication
(10) Pub. No.: US 2006/0045315 A1
(43) Pub. Date: Mar. 2, 2006

(54) Method and apparatus for acquiring biological information

(75) Inventors: Hirofumi Saitoh, Ogaki-city (JP); Tatsushi Ohyama, Ogaki-city (JP)

Correspondence Address: MCDERMOTT WILL & EMERY LLP, 600 13TH STREET, N.W., WASHINGTON, DC, 20005-3096, US

(73) Assignee: Sanyo Electric Co., Ltd.

(21) Appl. No.: 11/203,125

(22) Filed: Aug. 15, 2005

(30) Foreign Application Priority Data
Aug. 31, 2004 (JP) 2004-251476

(51) Int. Cl. G06K 9/00

(52) U.S. Cl. 382/115

(57) ABSTRACT

In a biological information acquisition apparatus, a biological acquisition unit acquires biological information. A sensitivity control unit varies sensitivity, with time, at which said biological acquires the biological information in a sensing period during which to acquire the biological information. A biological information recording unit records the biological information acquired respectively in accordance with a plurality of stages of sensitivity. The sensitivity control unit varies the sensitivity according a predetermined change pattern.

### BACKGROUND OF THE INVENTION

1. Field of the Invention

The present invention relates to the technology for acquiring biological information.

2. Description of the Related Art

Methods for identifying a valid individual may be roughly classified into three categories. One is identification by things that a person owns, such as a key or an ID card. This things-based authentication, however, has a drawback in that security can be compromised by possible loss or theft. Another is identification by the use of knowledge, such as a password. This knowledge-based authentication, too, has a security problem because people are forgetful and there may be furtive glances everywhere. A still another identification method drawing much attention of late years is biometric authentication, which uses such biological information as fingerprint, palm print, face image, iris image or voiceprint. The biometric authentication presents significantly reduced security concern over “loss,” which is inherent to the above-mentioned things-based or knowledge-based identification. And without the “need for the user to have” any particular thing or knowledge, the biometric identification can provide highly convenient identity authentication systems.

Because of these superior characteristics, personal authentication apparatuses using biometric information are expected to replace personal identification by what one has, such as a key to the house or car. In electronic commerce, which is increasingly widespread today, many of the personal identification methods are based on knowledge. In this area, too, there are growing expectations for more convenient and safer authentication apparatuses.

Related Art List

(1) Japanese Patent Application Laid-Open No. 2002-62108.
(2) Japanese Patent Application Laid-Open No. 2003-208620.

To assure greater convenience of a personal authentication apparatus based on biological information, it is necessary to acquire such biological information with accuracy. In the case of fingerprint authentication, it may be not only clear fingerprints but also unclear ones that are to be handled. The force with which a finger is pressed on the sensor may vary. Hence, there is a need for a technology that ensures the acquisition of satisfactory fingerprint images under any fingerprint collecting circumstances.

To solve this problem, one method conceivable may be such that when a fingerprint image acquired is not satisfactory, the fingerprint is acquired again after changing the sensor setting. Such a system requires a feedback control circuit for changing the sensor sensitivity according to the acquired fingerprint image, which in turn may make such a system more complex in structure and higher priced. Moreover, if much time is to be expended on the processing to optimize the sensor sensitivity, the system may become less convenient to use.

### SUMMARY OF THE INVENTION

The present invention has been made in view of the foregoing circumstances and problems, and an object thereof is to provide a technology for suitably acquiring biological information.

A biological information acquisition apparatus according to a preferred mode of carrying out the present invention varies sensitivity, with time, at which the biological information acquisition unit acquires the biological information in a sensing period during which to acquire the biological information, and records the biological information acquired respectively in accordance with a plurality of stages of sensitivity. At this time, the sensitivity of a sensor varies based on a predetermined change pattern.

In this apparatus, the sensitivity at which to acquire the biological information varies with time according to a predetermined pattern. For instance, if a user once places his/her finger on the sensor to input the biological information, a plurality of pieces of information corresponding to a plurality of stages of sensitivity can be acquired. If, after the input of the biological information, biological information suitable for identifying an individual is selected from among these pieces of biological information, a simple structure and the high accuracy in the acquisition of the biological information can be realized.

It is to be noted that any arbitrary combination of the above-described structural components and the expressions according to the present invention changed among a method, an apparatus, a system, a recording medium, a computer program and so forth are all effective as and encompassed by the present embodiments.

### BRIEF DESCRIPTION OF THE DRAWINGS

FIG. 1 illustrates a mode for carrying out the present invention when a fingerprint is acquired by a biological information acquisition apparatus.

FIG. 2 is functional block diagram for a biological information acquisition apparatus.

FIG. 3 is a time chart for explaining a sensitivity control by a sensitivity control unit.

FIG. 4 schematically illustrates fingerprint images obtained by a detection unit.

FIG. 5A shows a mode where two different kinds of sensors whose sensitivity differs from each other are arranged in a stripe shape so as to form a detection unit.

FIG. 5B shows a mode where two different kinds of sensors whose sensitivity differs from each other are arranged in a grid pattern so as to form a detection unit.

FIG. 6A is a graph showing a relationship between the pressure and the appropriate sensitivity range in a sensor adjusted for low pressure.

FIG. 6B is a graph showing a relationship between the pressure and the appropriate sensitivity range in a sensor adjusted for high pressure.

FIG. 7 is a graph showing a relationship between the pressing force and the appropriate sensitivity range when a low-pressure sensor and a high-pressure sensor are combined together.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

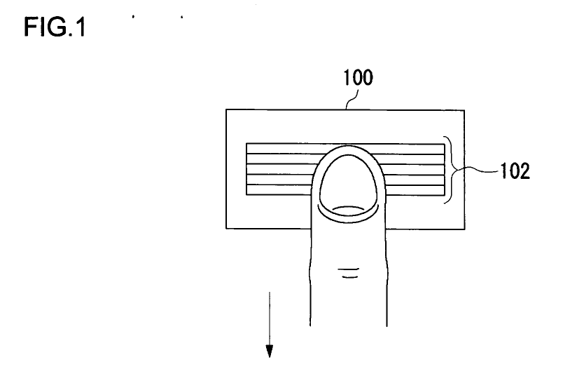

FIG. 1 illustrates how a fingerprint is collected by a biological information acquisition apparatus.

The user of a biological information acquisition apparatus 100 places his/her finger on a detection unit 102 and slides it in the direction of the arrow, which is downward in FIG. 1. The detection unit 102 functions as a so-called line sensor. In the present embodiment, the detection unit 102 is formed by an optical sensor. The detection unit 102 irradiates a fingerprint with light and acquires a fingerprint image by detecting the light reflected therefrom.

The detection unit 102 is formed by five optical sensors arranged side by side in a manner of stripes. Each sensor acquires a fingerprint image independently. That is, the five optical sensors independently acquire their respective fingerprint images. In this embodiment, the five optical sensors are all of the same type of sensor. These sensors are so designed that the sensitivity changes uniformly in a sufficiently short time interval as the user slides his/her finger and fingerprint images are picked up sequentially in synchronism with the change of sensitivity. Each sensor acquires part of an image (hereinafter referred to as “partial image”) of a fingerprint positioned directly above it each time of image pickup. The partial images thus sampled are then joined together to obtain an image of the whole fingerprint.

It is to be noted that the images picked up synchronously by these five optical sensors are joined together to form an image as part of the fingerprint directly above the detection unit 102 for one time of image pickup. In a modification of this embodiment, the image representing part of a fingerprint directly above the detection unit 102 picked up by a plurality of optical sensors may be defined as a “partial image”. In this case, each time an image pickup is carried out, the images acquired through the optical sensors undergoes a synthesis processing so as to acquire a partial image. It goes without saying that the detection unit 102 may be configured by a single optical sensor.

In this embodiment, the sensitivity is controlled in three predetermined stages. The sensitivity of the optical sensors changes cyclically through high sensitivity, intermediate sensitivity and low sensitivity according to the sampling period. For these three stages of sensitivity, their respective partial images are acquired by each of the sensors. These partial images may be partially overlapping each other. Three images of the whole fingerprint corresponding to the respective stages of sensitivity are generated by joining together the partial images for each of the different stages of sensitivity.

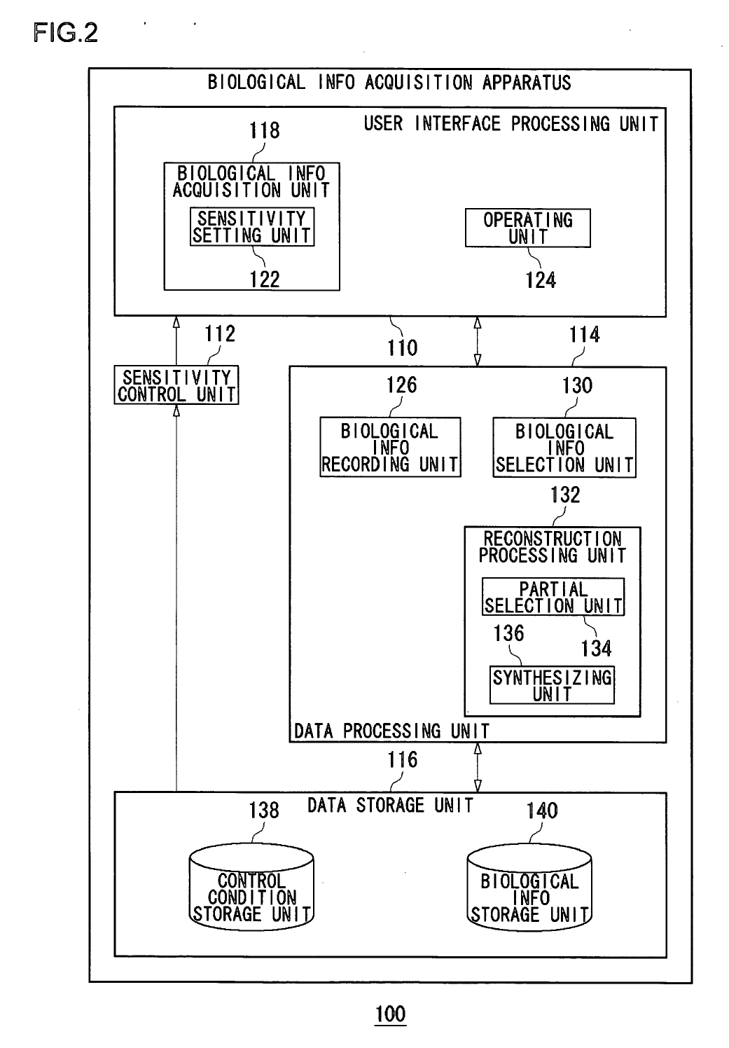

FIG. 2 is a functional block diagram of a biological information acquisition apparatus.

In terms of hardware, each block shown here can be realized by elements, such as a CPU of a computer, and a mechanical device. In terms of software, it can be realized by computer programs or the like, but drawn and described herein are function blocks that are realized in cooperation with those. Thus, it is understood by those skilled in the art that these function blocks can be realized in a variety of forms such as by hardware only, software only or the combination thereof.

The biological information acquisition apparatus 100 includes a user interface processing unit 110, a sensitivity control unit 112, a data processing unit 114 and a data storage unit 116.

The user interface processing unit 110 takes charge of performing a user interface processing. The sensitivity control unit 112 controls the detection sensitivity of the detection unit 102. The data storage unit 116 stores various types of data. The data processing unit processes the data stored in the data storage unit 116, based on operation contents inputted via the user interface processing unit 110 and the biological information acquired from the user interface processing unit 110.

The user interface processing unit 110 includes a biological information acquisition unit 118 and an operating unit 124. The biological information acquisition unit 118 acquires, as biological information, fingerprint information from a user through the detection unit 102. The biological information acquisition unit 118 includes a sensitivity setting unit 122. The sensitivity setting unit 122 sets the level of sensitivity in the detection unit 102 based on an instruction from the sensitivity control unit 112. The operating unit 124 receives operations from the user. The “operation” mentioned here may include an instruction as to the start or termination of acquiring the fingerprint information, for example. Besides the already mentioned functions, the user interface processing unit 110 may be equipped with notification functions by which various kinds of information is displayed to the user or the audio is outputted. For instance, the acquisition of biological information or the completion of authentication may be notified to the user via the LED, screen display, audio or the like.

The data storage unit 116 includes a control condition storage unit 138 and a biological information storage unit 140.

The control condition storage unit 138 stores data serving as a control condition with which the sensitivity control unit 112 controls the setting of the sensitivity setting unit 122. The sensitivity control unit 112 instructs the sensitivity setting unit 122 so that a predetermined sensitivity is set at a predetermined timing in accordance with this control condition. The biological information storage unit 140 stores the biological information acquired from the biological information acquisition unit 118.

The data processing unit 114 includes a biological information recording unit 126, a biological information selection unit 130 and a reconstruction processing unit 132.

The biological information recording unit 126 records biological information acquired by the biological information acquisition unit 118 in the biological information storage unit 140. The sensitivity control unit 112 controls the sensitivity of the biological information acquisition unit 118 wherein the sensitivity is set in a plurality of stages. If the sensitivity is set in three stages, three kinds of fingerprint images are acquired according to these three stages of sensitivity. The biological information recording unit 126 joins together the respective partial images obtained from their respective sensors of the detection unit 102, and then records a fingerprint image in the biological information storage unit 140 for each stage of sensitivity. Instead of joining the partial images, the information recording unit 126 may classify them for each stage of sensitivity and record them in the biological information storage unit 140.

The biological information selection unit 130 selects a fingerprint image. According to a predetermined condition for selection, the biological information selection unit 130 selects one appropriate fingerprint image from among the fingerprint images joined together for each sensitivity. The biological information recording unit 126 may reduce and thus economize the amount of storage data by recording a selected fingerprint image only in the biological information storage unit 140 and deleting the rest therefrom. A fingerprint image is acquired as a monochrome image of black and white. The biological information selection unit 130 selects a fingerprint image according to the clarity of separation between the white region and the black region of a fingerprint image. This arrangement is used because a fingerprint image with clear-cut borderlines between white and black, which are the edges of the fingerprint, is suitable in identifying a person's characteristics. More specifically, the arrangement may be such that a fingerprint image is classified into the white, black and gray regions according to predetermined threshold values and a fingerprint image with the smallest gray region is selected as the most appropriate fingerprint image. Otherwise, a fingerprint image may be selected according to the ratio between the width of a ridge line indicative of a projected portion of a fingerprint in the fingerprint image and the width of a furrow line, indicative of a recessed portion thereof, between the ridge lines. It should be understood that the method of selecting and determining a fingerprint image may be any of various other known methods.

The reconstruction processing unit 132 generates a suitable fingerprint image by selecting the most appropriate images for each of partial images. The reconstruction processing unit 132 includes a partial selection unit 134 and a synthesizing unit 136. The partial selection unit 134 selects a fingerprint image for each set of partial images. As mentioned above, the biological information recording unit 126 may store partial images in the biological information storage unit 140 not joining them together but classifying them by sensitivity. The partial selection unit 134 selects suitable partial images for each predetermined part using part information classified by each of the three stages of sensitivity. The synthesizing unit 136 generates an entire fingerprint image by joining together the partial images selected by the partial selection unit 134. In this case, a suitable fingerprint image can more likely be generated as a whole even when the image is partially faulty due to uneven pressure of a finger applied and so forth.

It is to be noted that the data storage unit 116 may store, as registrant information, suitable fingerprint images, which have been acquired by the biological information acquisition unit 118 and processed by the data processing unit 114, and feature information, which is extracted from those fingerprint images for personal identification. And a system may be structured as a personal authentication apparatus including an authentication unit which verifies the user's identity by comparing the fingerprint image acquired from an authenticatee or its feature information with the registrant information.

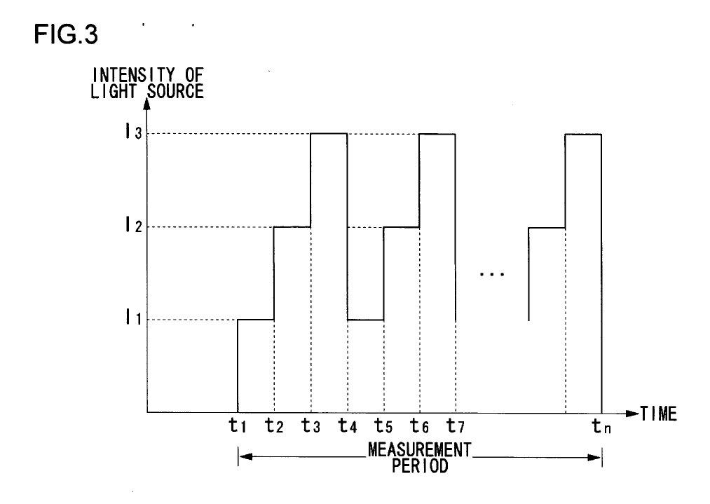

FIG. 3 is a time chart for explaining the sensitivity control by the sensitivity control unit 112.

The horizontal axis is time, and the vertical axis is the intensity, or the brightness, of the light source of an optical sensor. If the irradiated light from the light source of the optical sensor changes, the ratio between the white region and the black region in a fingerprint image changes. In other words, the sensitivity of the optical sensor can be controlled in relation to the intensity of irradiated light. In addition, the wavelength of irradiated light or the direction of irradiation may be changed. Or the conditions for light reception at the pickup of a fingerprint image may be changed. For example, if the signal current is to be outputted according to the volume of received light, the sensitivity to light reception may be changed by controlling the amplification factor for the signal current. In the case when a pressure-sensitive sensor is used, the sensitivity to pressure may be controlled. For example, where the signal current is outputted according to the pressure detected by a pressure detecting device, such as a piezoelectric element, the sensitivity to pressure may be controlled by controlling the amplification factor for the signal current.

In this embodiment, the intensity of the light source is switched sequentially in three stages of I₁, I₂ and I₃. The inputting of biological information is started at time t₁. After the start of the inputting of biological information, the user slides his/her finger placed on the detection unit 102. And, in a predetermined sampling period, each optical sensor of the detection unit 103 captures a partial image positioned directly above it. This sampling interval is set to a sufficiently short time in relation to the biological information acquisition period, which is the period during which the user slides his/her finger. It is to be noted here that in the inputting of biological information, the detection unit 102 itself may scroll. Furthermore, the detection unit 102 may function as an area sensor, instead of as a line sensor. Described herein is the case where the biological information recording unit 126 classifies partial images by sensitivity and records them, without altering or modifying them, in the biological information storage unit 140.

At time t₁, each sensor of the detection unit 102 captures a partial image of a fingerprint positioned directly above it at the light source intensity of I₁. The biological information recording unit 126 records these partial images in the biological information storage unit 140. At time t₂, the light-source intensity of each sensor changes to I2. The sensitivity control unit 112, according to the control condition data stored in the control condition storage unit 138, instructs the sensitivity setting unit 122 to set the light source intensity to I₂ at the time t₂. After the sensitivity setting unit 122 has changed the setting to the light source intensity I₂, the biological information acquisition unit 118 captures partial images again. At this time, too, five partial images are acquired by the five sensors of the detection unit 102. In this manner, these small pieces of fingerprint images are acquired by the five sensors, respectively. These five partial images are recorded in the biological information storage unit 140 as the partial images corresponding to the light source intensity of I₂.

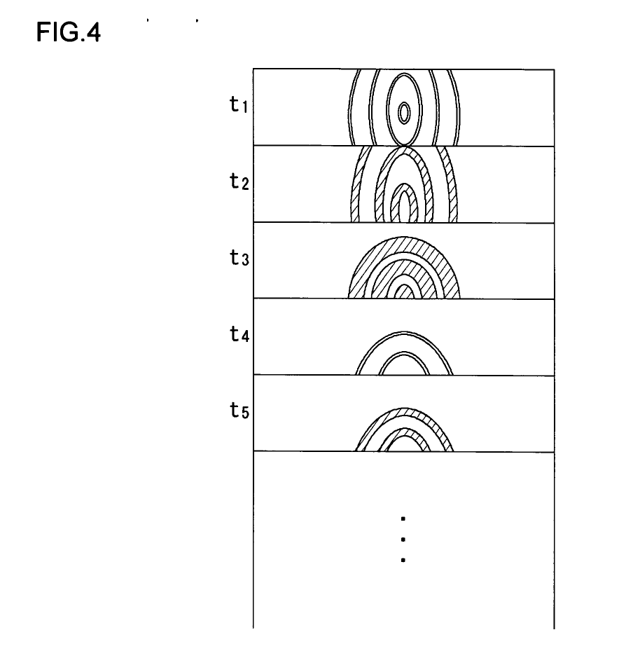

FIG. 4 schematically illustrates fingerprint images obtained by a detection unit 102.

FIG. 4 shows partial images acquired from a single optical sensor in the detection unit 102. Each sensor of the detection unit 102 captures partial images of a fingerprint directly above it while the sensitivity is being adjusted by the sensitivity control unit 112 at predetermined timing. At time t₁, the image of a central part of a fingerprint is picked up as the partial image. As shown in FIG. 3, at time t₁, the intensity of the light source of the detection unit 102 is set to I₁, which is the weakest in the three stages of intensity. Thus, the captured ridge lines of a fingerprint in the fingerprint are narrow.

At time t₂, the finger moves to a downward position than the position at time t₁, so that the partial image to be captured will be an image of a fingerprint even closer to the fingertip. At time t₂, the intensity of the light source is I₂ which is the intermediate level in the three stages of sensitivity. Thus, the captured ridge lines thereof at time t₂ are thicker than those at time t₁. At time t₃, the ridge lines thereof will be even thicker and the partial image which is even closer to the tip of a fingerprint will be acquired. In this manner, the partial images of a fingerprint corresponding to the respective stages of sensitivity are acquired from the respective optical sensors.
1. The biological information recording unit 126 may synthesize three fingerprint images by joining together the partial images for each of three stages of sensitivity. In this case, the biological information selection unit 130 selects a suitable fingerprint image from among a plurality of synthesized fingerprint images. From the selected fingerprint image, features, such as endings and bifurcations, by which to identify an individual may be extracted so as to be used for a personal authentication.
2. The biological information recording unit 126 may classify the partial images for each of the three stages of sensitivity, and record them in the biological information storage unit 140 as they are. In such a case, the partial selection unit 134 may compare the partial images obtained from the respective sensors, and select a suitable partial image for each part. The synthesizing unit 136 may join these selected partial images together so as to synthesize and generate an entire fingerprint image. The thus synthesized image is such that the sensitivity set at the time of image acquisition may possibly differ for each part.

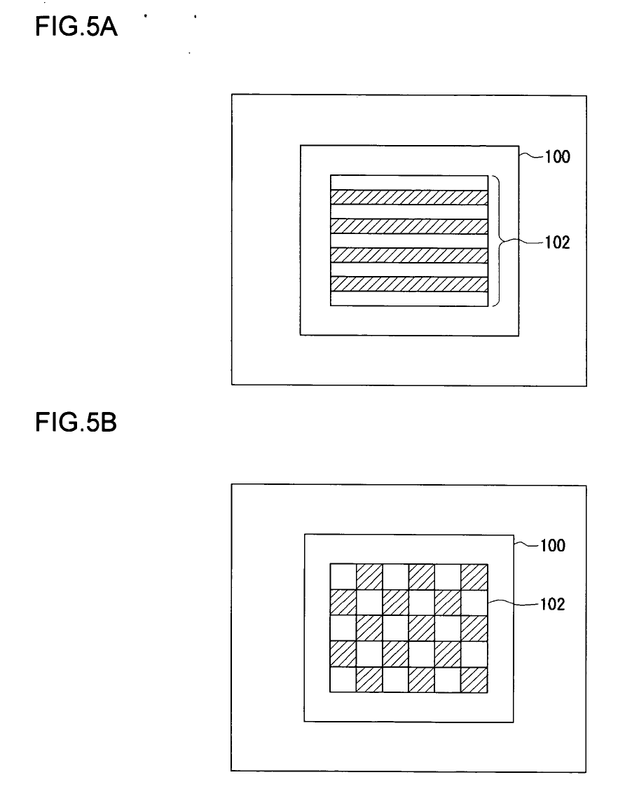

FIGS. 5A and 5B show examples of arrangement of a detection unit in which a plurality of sensors that differ in sensitivity are apposed in parallel fashion.

In the present embodiment shown above, a plurality of the same type of sensors are apposed in parallel fashion and the sensitivity is varied with time. As another method for acquiring the biological information corresponding respectively to a plurality of stages of sensitivity by one time input operation of biological information, the detection unit 102 may be formed by a plurality of biological sensors whose sensitivity differs from one another in the first place.

FIG. 5a shows a mode where two kinds of sensors whose sensitivity differs from each other are arranged in a stripe shape so as to form a detection unit 102. FIG. 5B, on the other hand, shows a mode where two kinds of sensors whose sensitivity differs from each other are arranged in a grid pattern so as to form a detection unit. In either FIG. 5a or FIG. 5B, the sensors indicated with oblique lines differ in sensitivity from those indicated with no oblique lines. In this manner, if the sensors that differ in sensitivity are arranged alternately, fingerprint images corresponding respectively to a plurality of stages of sensitivity can be acquired by the one-time operation of inputting the biological information. In this case, too, a suitable fingerprint may be selected from among the fingerprint images acquired from the sensors of the respective stages of sensitivity. Or, a suitable image may be selected for each set of partial images. And if such partial images selected in this manner are synthesized, a fingerprint image can be more suitably generated than that acquired by sensors of a single kind.

The sensitivity may be set corresponding to so-called wet finger and dry finger. That is, in the case of wet fingers, the fingerprint image is acquired by a sensor which obtains images of good quality even if the contact area is large. And in the case of dry fingers, it is acquired by a sensor which obtains images of good quality even if the contact area is narrow. As a result, the fingerprint image can be desirably acquired regardless of variations in the finger moisture.

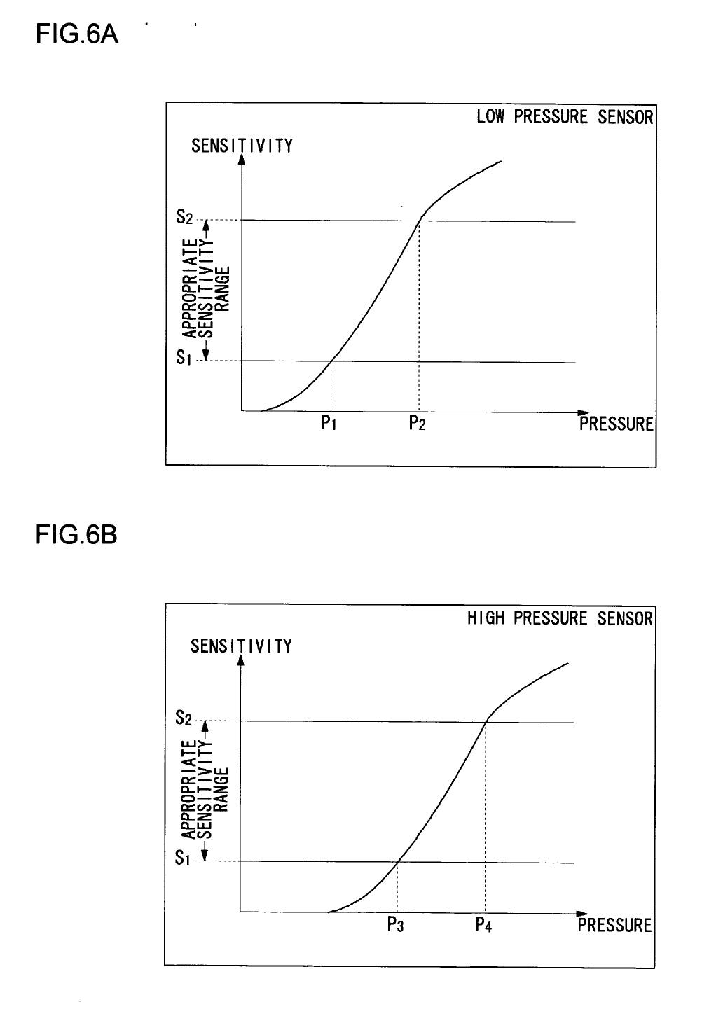

FIGS. 6A and 6B are graphs each showing a relationship between the pressure applied to a sensor and the appropriate sensitivity range in the conventional sensor.

FIG. 6A is a graph showing a relationship between the pressure and the appropriate sensitivity range in a sensor adjusted for low pressure FIG. 6B is a graph showing a relationship between the pressure and the appropriate sensitivity range in a sensor adjusted for high pressure. Hereinafter, the sensor adjusted for low pressure will be. referred to as “low-pressure sensor” and the sensor adjusted for high pressure will be referred to as “high-pressure sensor”.

In FIG. 6A, if the pressure applied to a sensor (hereinafter referred to as “pressing force”) lies within the range between P₁ and P₂, the fingerprint can be appropriately acquired. In other words, the sensitivity falls within the appropriate sensitivity range of S₁ to S₂. If the pressing force is smaller than or equal to P₁, the ridge lines of a fingerprint in a fingerprint image will get thinner, in which case it is hard to extract the feature of a fingerprint. If, on the other hand, the pressing force is larger than or equal to P₂, the ridge lines of a fingerprint in a fingerprint image will get unwieldily thicker, in which case it is also hard to extract the feature of a fingerprint. In the case of a low-pressure sensor as shown in FIG. 6a, the fingerprint can be desirably acquired if a user holds his/her finger down on a sensor within the range between P₁ and P₂.

Referring to FIG. 6B, a fingerprint image can be appropriately acquired if the pressing force lies within the range between P₃ and P₄. Since this sensor is the high pressure sensor, P₃ is larger than P₁ and P₄ is larger than P₂. If the pressing force is smaller than or equal to P₃, the ridge lines of a fingerprint in a fingerprint image will get thinner, in which case it is hard to extract the feature of a fingerprint. If, on the other hand, the pressing force is larger than or equal to P₄, the ridge lines of a fingerprint in a fingerprint image will get unwieldily thicker, in which case it is also hard to extract the feature of a fingerprint. In the case of a high-pressure sensor as shown in FIG. 6B, the fingerprint can be desirably acquired if the user holds his/her finger down on the sensor within the range between P₃ and P₄.

Accordingly, although in comparison with the high pressure sensor the low-pressure sensor can acquire a desirable fingerprint even if the pressing force is small, accuracy is inferior compared to when the pressing force is large. In contrast thereto, although the high-pressure sensor is superior in extracting the feature of a fingerprint when the pressing force is large, accuracy is inferior to the low-pressure sensor when the pressing force is small.

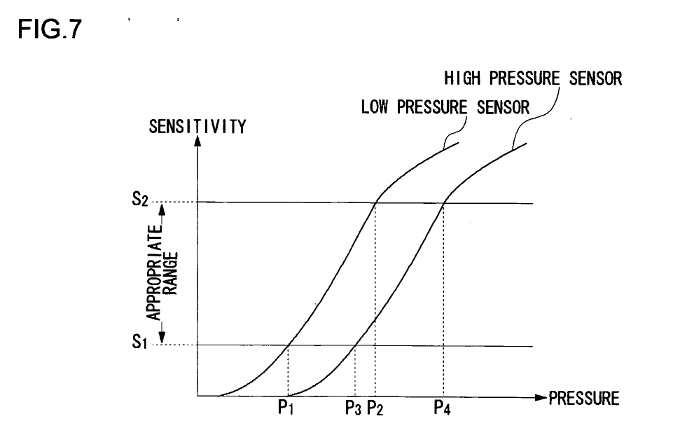

FIG. 7 is a graph showing a relationship between the pressing force and the appropriate sensitivity range when the low-pressure sensor and the high-pressure sensor are combined together.

Referring to FIG. 7, the pressing force lying between P₁ and P₂ corresponding to the appropriate sensitivity range of the low-pressure sensor and the pressing force lying between P₃ and P₄ corresponding to the appropriate sensitivity range of the high-pressure sensor are set in the overlapping manner. As a result, an appropriate sensitivity range is set corresponding to the range covering the pressing forces P₁ through P₄. Hence, this scheme can deal with a range broader than the case when the fingerprint image is acquired by the high-pressure sensor only or the low-pressure sensor only.

According to the present embodiments, the sensitivity of a sensor is varied-with time, so that a broader range of pressing force can be covered as described above. Furthermore, as described with reference to FIG. 5A and FIG. 5B, a plurality of sensors whose sensitivity differs from one another are apposed in parallel fashion, so that a still broader range of pressing force can be dealt with.

By employing the biological information acquisition apparatus 100 according to the present embodiments as described above, the fingerprint images can be easily acquired in a suitable manner in a variety of situations where the fingerprints are acquired. The provision of a control unit, where fingerprint images are acquired and the quality of images is determined so as to adjust the sensitivity of a sensor, is not required.

The fingerprint images are acquired, the quality of images is determined and therefore the provision of a control circuit for adjusting the sensitivity of a sensor is not required. Hence, there can be provided a biological information acquisition apparatus 100 which is moderately priced and simple in structure. If the reconstruction processing unit 132 suitably selects an image for each set of partial images, the fingerprint image as a whole can be acquired with ease more suitably even in the event that a variation in density is caused by the partial unevenness in the pressing force of a finger. To a user, one-time operation of inputting the biological information realizes the acquisition of biological information corresponding respectively to a plurality of stages of sensitivity and then a determination processing by the biological information selection unit 130 and the reconstruction processing unit 132. Thus, compared with the feedback control otherwise carried out, the user does not have to place his/her finger for a long time on the detection unit 102, so that the apparatus is superior also in terms of the user interface.

The present invention has been described based on the embodiments which are only exemplary. It is understood that the present invention is not limited to the embodiments described above and various modifications are also effective as and encompassed by the embodiments of the present invention.

In the above embodiments, the description has been given of acquisition of a fingerprint as an example. However, the scope of the present invention is not limited thereto. For example, when the image information, such as palm print, venous information or face image, are acquired as the biological information,. each of those pieces of biological information may be acquired based on a plurality of stages of sensitivity as described above. The present invention is also applicable, in the similar manner, to the acquisition of any type of information other than image information, including the voice information, such as voiceprint.

The environment, in which the biological information is acquired, varies disproportionately depending on a user or the installation location of a biological acquisition information apparatus. The biological information apparatus may record the sensitivity obtained when the biological information has been suitably acquired and may set, based on the thus recorded information, the range of sensitivity to vary wherein a sensitivity with which the biological information is suitably acquirable is set as the center of the range. According to such a control as this, the variable sensitivity range changes autonomously even if the sensitivity deteriorates due to the dirt on the surface of a sensor or the like, so that the adjustment can be easily made to cope with the deterioration due to aging.

Although the present invention has been described by way of exemplary embodiments and modifications, it should be understood that many other changes and substitutions may further be made by those skilled in the art without departing from the scope of the present invention which is defined by the appended claims.

What is claimed is:

1. A biological information acquisition apparatus, comprising:
a biological information acquisition unit which acquires biological information;
a sensitivity control unit which varies sensitivity, with time, at which said biological information acquisition unit acquires the biological information in a sensing period during which to acquire the biological information; and
a biological information recording unit which records the biological information acquired respectively in accordance with a plurality of stages of sensitivity,
wherein said sensitivity control unit varies the sensitivity according a predetermined change pattern.

2. A biological information acquisition apparatus according to claim 1, wherein said biological information acquisition unit acquires the biological information by using an optical sensor, and
wherein said sensitivity control unit varies sensitivity of the optical sensor by changing a setting condition of a light source that irradiates a biological body with light.

3. A biological information acquisition apparatus according to claim 1, wherein said biological information acquisition unit acquires, as a biological image; the biological information by an optical sensor, and
wherein said sensitivity control unit varies sensitivity of the optical sensor by changing a light receiving condition with which the biological image is picked up.

4. A biological information acquisition apparatus according to claim 1, wherein said biological information acquisition unit acquires the biological information by using a pressure-sensitive sensor, and
wherein said sensitivity control unit varies sensitivity relative to pressure of the pressure-sensitive sensor.

5. A biological information acquisition apparatus according to claim 1, further comprising a biological information selection unit which selects, based on a predetermined selection condition, any of the biological information from among the biological information recorded in said biological information recording unit.

6. A biological information acquisition apparatus according to claim 2, further comprising a biological information selection unit which selects, based on a predetermined selection condition, any of the biological information from among the biological information recorded in said biological information recording unit.

7. A biological information acquisition apparatus according to claim 3, further comprising a biological information selection unit which selects, based on a predetermined selection condition, any of the biological information from among the biological information recorded in said biological information recording unit.

8. A biological information acquisition apparatus according to claim 4, further comprising a biological information selection unit which selects, based on a predetermined selection condition, any of the biological information from among the biological information recorded in said biological information recording unit.

9. A biological information acquisition apparatus according to claim 1, further comprising:
a partial selection unit which selects, for a predetermined part of the biological information, the predetermined part of the biological information from among the biological information recorded in said biological information recording unit, based on a predetermined condition; and
a biological generation unit which synthesizes parts of the biological information selected by said partial selection unit so as to generate new biological information.

10. A method for acquiring biological information, the method comprising:
acquiring biological information;
detecting timing, at which a sensitivity to acquire the biological information is switched, by referring to a predetermined timing table;
switching the sensitivity to a predetermined degree of sensitivity by referring to a predetermined sensitivity switching table upon reaching said timing; and
acquiring again the biological information at the predetermined degree of sensitivity switched by said switching.
